(19) United States
(12) Patent Application Publication
(10) Pub. No.: US 2006/0241211 A1
(43) Pub. Date: Oct. 26, 2006

(54) Effect Pigment

(76) Inventors: Gregory Coughlin, Nanuet, NY (US); Robert Juby, Cold Spring, NY (US)

Correspondence Address: BASF CATALYSTS LLC, 101 WOOD AVENUE, ISELIN, NJ, 08830, US

(21) Appl. No.: 11/379,863

(22) Filed: Apr. 24, 2006

Related U.S. Application Data
(60) Provisional application No. 60/674,648, filed on Apr. 25, 2005.

(51) Int. Cl. C09C 1/00; C04B 14/00; C11C 3/00; C08K 9/00

(52) U.S. Cl. 523/200; 106/415; 106/479; 106/504

(57) ABSTRACT

The present invention provides an effect pigment comprising: (a) substrate optionally coated with metal oxide; and (b) triacetin. The present effect pigment may be used in cosmetics, plastics, security markings, inks, coatings including solvent and water borne automotive paint systems, and unsaturated polyester buttons.

This patent application claims the benefit of U.S. Ser. 60/674,648 filed Apr. 25, 2005 incorporated herein by reference in its entirety.

### BACKGROUND

The use of effect pigments, also known as pearlescent pigments or nacreous pigments, in order to impart a pearlescent luster, metallic luster and/or multi-color effect approaching iridescent, is well-known. The effect pigments are composed of a plurality of laminar platelets, each of which is coated with one or more reflecting/transmitting layers. Pigments of this type were first based on metal oxides, as described in U.S. Pat. Nos. 3,087,828 and 3,087,829, and a description of their properties can be found in the L. M. Greenstein, “Nacreous (Pearlescent) Pigments and Interference Pigments”, Pigment Handbook, Volume I, Second Edition, pp. 829-858, John Wiley & Sons, NY (1988) More recently, use of other coating layers to realize optically variable effects have been developed.

The unique appearance of effect pigments is the result of multiple reflections and transmissions of light. The platelet substrate usually has a refractive index which is different from the coating and usually also has a degree of transparency. The coating is in the form of one or more thin films which have been deposited on the surfaces of the platelets.

There are a number of important aspects to effect pigments. One is that they are commonly composed of a plurality of particles which are platelet shaped. If there is a different size or shape, the pearlescent or nacreous appearance is significantly diminished and usually lost to a degree that the material no longer functions as an effect pigment.

One important aspect of the coating on the platelet is that it must be smooth and uniform in order to achieve the optimum pearlescent appearance. The reason is that if an irregular surface is formed, light scattering occurs and the coated platelet will no longer function as an effect pigment.

In addition, the coating should adhere strongly to the platelet or else the coating will become separated during processing, resulting in considerable breakage and loss of luster. Particles which do not become attached to the platelet during preparation of the coatings on the platelets or which are the result of separation cause light scattering and impart opacity to the pigment. When there are too many of such small particles, the pearlescent appearance can be reduced or lost.

The addition of the coatings to a platelet so that the luster, color and color homogeneity are maintained is a very complex process and originally, the only platy substrate which achieved any significant use in commerce was mica. With the advent of synthetic substrates, e.g. synthetic mica, aluminum oxide, silica, and glass, it became evident that other substrates could be used since each substrate itself contributes certain effect attributes, due to variations in transparency, refractive index, bulk color, thickness, and surface and edge features. Coated substrate effect pigments thus provide different, albeit similar, visual effects when they are identical except for the identity of the material of the platelet because of these considerations.

Some effect pigments are combined with plasticizers in order to work in the intended application. With European directives prohibiting the use of phthalate plasticizers in certain products, a need existed in the art to develop suitable phthalate-free plasticizers. In addition to being phthalate-free, suitable plasticizers must provide sufficient gloss and coverage. Gloss is the relative amount of light reflected from a given substrate. Coverage is the degree of opacity. The degree by which light passes through a substrate or the amount of coated surface is visible through the coating.

Merck Bi-flair 88L dpf pigment comprises bismuth oxychloride crystal.

### SUMMARY

The present invention responds to the need in the art by providing an effect pigment comprising: (a) substrate optionally coated with metal oxide; and (b) triacetin. The present effect pigment advantageously has favorable flow and processing characteristics.

### DESCRIPTION

Plasticizer:

We have found that a useful phthalate-free plasticizer for effect pigments is triacetin (also known as glycerol triacetate). Triacetin advantageously may act as a carrier for the effect pigment to improve handling and dispersion thereof.

The amount of triacetin used per effect pigment depends on the intended end application. In general, the amount of triacetin used is from about 75 to about 350 weight percent based on the amount of effect pigment. In other words, the amount of triacetin used in anywhere from slightly less than equal to the amount of effect pigment to 3.5 times the amount of effect pigment. The triacetin functions as a plasticizer.

Effect Pigment:

The substrates used in the present invention may have any morphology including platelet, spherical, cubical, acicular, whiskers, or fibrous. Examples of useful platy materials include natural mica, synthetic mica, platy aluminum oxide, platy glass, aluminum, bismuth oxychloride, platy iron oxide, platy graphite, platy silica, bronze, stainless steel, natural pearl, boron nitride, silicon dioxide, copper flake, copper alloy flake, zinc flake, zinc alloy flake, zinc oxide, enamel, china clay, porcelain, and mixtures thereof.

Examples of useful spherical substrate materials include glass, plastic, ceramic, metal, or an alloy and the spheres may be solid or hollow. Useful glass spheres are disclosed in U.S. Pat. No. 5,217,928, incorporated in its entirety herein by reference.

Useful cubical material includes glass cubes.

Glass can be classified for example as A glass, C glass, E glass, and ECR glass. Glass types which fulfill the feature of the requested softening point are quartz glass, and any other glass composition having a softening point of ≧800° C. Glass flakes which fulfill the requirements are special glasses like e.g. Schott Duran or Supremax types. The softening point is defined, according to ASTM C 338 as the temperature at which a uniform fiber of glass with a diameter of 0.55-0.75 mm and a length of 23.5 cm increases its length by 1 mm/min when the upper 10 cm. is heated at a rate of 5° C./min. Other useful glass flakes have a thickness of ≦1.0 micron and a softening point ≧800° C. A boron free glass may also be used.

Examples of useful mixtures of at least two different materials are in the following table:

| FIRST MATERIAL | SECOND MATERIAL |
|---|---|
| A Glass | C Glass |
| A Glass | E Glass |
| A Glass | ECR Glass |
| A Glass | Quartz Glass |
| C Glass | E Glass |
| C Glass | ECR Glass |
| C Glass | Quartz Glass |
| E Glass | ECR Glass |
| E Glass | Quartz Glass |
| Silicon carbide | Mica |
| Glass spheres | Mica |
| Predominantly iron oxide | Glass spheres |
| containing other oxides | |
| Predominantly iron oxide | Mica |
| containing other oxides | |
| Zinc oxide | Glass |
| Metal or alloy | Glass |
| Ceramic microspheres | Mica |
| Glass bubbles | Mica |

The average particle size of the substrate preferably used may vary from an average of about 3 microns to an average of about 1,000 microns, although smaller substrates of down to about 1 micron or less or larger flakes of up to 150 microns or more may also be used if desired. The substrates have a thickness of about 0.1 micron to about 10 microns and an aspect ratio (average particle size/thickness) of at least about 10.

The substrate may be used alone or optionally coated with at least one metal oxide.

A metal oxide coated substrate may be accomplished, as one example, by precipitating the metal ion onto laminar platelets and thereafter calcining the coated platelets to provide metal oxide-coated platelets. The metal oxide in most widespread use is titanium dioxide, followed by iron oxide. Other usable oxides include (but are not limited to) tin, chromium and zirconium oxides as well as mixtures and combinations of oxides. For convenience, the description of this process which follows will be primarily concerned with titanium and iron as the metal of the oxide but it will be understood that any other known metal or combination of metals can be used.

The layers encapsulating the substrate may alternate between high refractive index materials and low refractive index materials. High refractive index materials include those with a refractive index from about 2.00 to about 3.10. Low refractive index materials include those with a refractive index from about 1.30 to about 1.80. The high refractive index materials may be anatase titanium dioxide, rutile titanium dioxide, iron oxide, zirconium dioxide, zinc oxide, zinc sulfide, bismuth oxychloride or the like. The CRC Handbook of Chemistry and Physics, 63^{rd} Edition reports refractive indices for these high refractive index materials as follows.

| Material | Refractive Index |
|---|---|
| TiO2 - anatase | 2.55 |
| TiO2 - rutile | 2.90 |
| Fe2O3 - hematite | 3.01 |
| ZrO2 | 2.20 |
| ZnO | 2.03 |
| ZnS | 2.38 |
| BiOCl | 2.15 |

The low refractive index material may be silicon dioxide, magnesium fluoride, aluminum oxide, a polymer such as polymethyl methacrylate, polystyrene, ethylene vinyl acetate, polyurea, polyurethane, polydivinyl benzene and the like. The CRC Handbook of Chemistry and Physics, 63^{rd} Edition reports refractive indices for these low refractive index materials as follows.

| Material | Refractive Index |
|---|---|
| SiO2 - amorphous | 1.46 |
| MgF2 | 1.39 |
| Al2O3 | 1.76 |
| Polymers | 1.4-1.6 is typical |

Other useful combinations of metal oxides include SiO₂ on calcium aluminum borosilicate and then TiO₂ thereon; substrate/SiO₂/Fe₂O₃; substrate/TiO₂/SiO₂; substrate/TiO₂/SiO₂/TiO₂; substrate/Ti O₂/SiO₂/Fe₂O₃: substrate/TiO₂/SiO₂/Cr₂O₃; substrate/Fe₂O₃/SiO₂; substrate/Fe₂O₃/SiO₂/Fe₂O₃; substrate/Fe₂O₃/SiO₂/TiO₂; substrate/Fe₂O₃/SiO₂/Cr₂O₃; substrate/Cr₂O₃/SiO₂/Cr₂O₃; and substrate/Cr₂O₃/SiO₂/Fe₂O₃. Other combinations of the above mentioned layers are obvious to one skilled in the art.

An interlayer to enhance performance attributes may also be used. Useful interlayer materials include the hydroxides and oxides of Al, Ce, Cr, Fe, Mg, Si, Ti, and Zr. Essentially any organic or inorganic substance may be a useful interlayer for adhesion promotion, mechanical integrity, product enhancement, or other desirable attributes.

In general, the procedure involves dispersing the particulate (flakes) and combining that dispersion with a precursor which results in the formation of a titanium oxide or iron oxide precursor coating on the flakes. Usually, the particulate or flakes are dispersed in water, which is preferably distilled. The concentration of the particulate in the water can vary from about 5 to 60%, although the generally preferred concentrations vary between about 10 and 20%.

To the water/particulate slurry is added an appropriate metal ion source material. In the case of titanium, titanyl chloride or titanium tetrachloride is preferably used and in the case of iron, the source material is preferably ferric chloride. The pH of the resulting slurry is maintained at an appropriate level during the addition of the titanium or iron salt by the use of a suitable base such as sodium hydroxide in order to cause precipitation of a titanium dioxide or iron oxide precursor on the particulate. Increasing the thickness gives rise to interference colors. If desired, layers of titanium and iron hydroxide and/or oxide (or other metals) can be deposited sequentially. If necessary to lower the pH, an aqueous acid such as hydrochloric acid can be used. The coated platelets can, if desired, be washed and dried before being calcined to the final effect pigment.

When titanium dioxide-coated products are prepared, both anatase and rutile crystal modifications are possible. The highest quality and most stable pearlescent pigments are obtained when the titanium dioxide is in the rutile form. Some substrates, including both mica and glass, are anatase directing, and it is therefore necessary to modify the foregoing procedure if a rutile product is desired. The modifications necessary to realize a rutile TiO₂ are known in the art. One procedure involves the precipitation of a tin hydroxide or oxide entity on the surface of the particulate before the formation of the layer of titanium dioxide precursor. The layered combination is processed and calcined. This procedure is described in detail in U.S. Pat. No. 4,038,099, which is incorporated herein by reference. An alternative procedure is described in U.S. Pat. No. 5,433,779, the disclosure of which is also incorporated by reference, and involves deposition of the titanium dioxide precursor on the substrate in the presence of iron and calcium, magnesium and/or zinc salts without the use of tin. While rutile coatings are preferred, it can be desirable to produce anatase coatings and this is also within the scope of the present invention.

Other coating procedures, such as for example, chemical vapor deposition processes, can also be used.

Optically variable effect pigments have been developed more recently. These are constructed with the substrate being coated with a reflecting layer (e.g., silver, gold, platinum, palladium, rhodium, ruthenium, osmium, iridium or their alloys) which is overcoated with a low index of refraction material, typically having a refractive index from 1.3 to 2.5, that provides a variable path length for light dependent on the angle of incidence of light impinging thereon (for instance, MgF₂ or SiO₂), which in turn may be overcoated with a third layer selectively transparent to light directed thereon (e.g., silicon, iron oxide, chromium oxide, a mixed metal oxide, titanium dioxide, titanium nitride and aluminum, as well as the same materials as the first layer provided they are sufficiently thin as to be selectively transparent). Examples of such pigments and the processes by which they can be produced can be found, for example, in U.S. Pat. Nos. 5,135,812; 4,434,010 (teaching for example alternating layers of TiO₂ and SiO₂); 5,059,245; 5,281,480; 5,958,125; 6,160,208; 6,325,847; 6,440,208; and 6,875,264, the disclosures of which are all also incorporated by reference.

The substrate coating procedure employed is adjusted such that the two or more substrate materials coat at substantially the same rate to thereby develop a coating of similar quality and thickness. This may involve control of the temperature, reagent addition rate, reagent identity, substrate pretreatment, and the like. Frequently, this control is more easily achieved as the platelets become closer to each other in average size and thickness. The modifications necessary or appropriate can easily be established by those of skill in this art with a few preliminary runs to establish the appropriate parameters.

The coated substrates, however produced, can be post-treated by any procedure known in the art. Examples of such treatments can for instance be found in U.S. Pat. Nos. 4,134,776; 5,091,011; 5,156,889; 5,326,392; 5,423,912; 5,759,255; and 6,325,846, which are hereby incorporated herein by reference, but are not limited to those procedures.

Depending on the intended use, the present effect pigment may benefit from some form of a surface treatment. Non-limiting examples would be a coupling agent with or without a metal hydroxide for enhanced exterior stability. Often metal compounds are added as surface treatments with and without organic compounds to vary the surface charge of the particles and/or vary the tactile properties.

Utility:

The resulting pigment can be used in any application for which effect pigments have been used heretofore such as, for instance, in cosmetics, plastics, security markings, inks and coatings including solvent and water borne automotive paint systems. Other uses include molded articles such as unsaturated polyester buttons. Products of this invention have an unlimited use in all types of automotive and industrial paint applications, especially in the organic color coating and inks field where deep color intensity is required. For example, these pigments can be used in mass tone or as styling agents to spray paint all types of automotive and non-automotive vehicles. Similarly, they can be used on all clay/formica/wood/glass/metal/enamel/ceramic and non-porous or porous surfaces. The pigments can be used in powder coating compositions. They can be incorporated into plastic articles geared for the toy industry or the home. Security applications such as inks and coatings are a valuable use for these products. These pigments can be impregnated into fibers to impart new and esthetic coloring to clothes and carpeting. They can be used to improve the look of shoes, rubber and vinyl/marble flooring, vinyl siding, and all other vinyl products. In addition, these colors can be used in all types of modeling hobbies.

The above-mentioned compositions in which the compositions of this invention are useful are well known to those of ordinary skill in the art. Examples include printing inks, nail enamels, lacquers, thermoplastic and thermosetting materials, natural resins and synthetic resins. Some non-limiting examples include polystyrene and its mixed polymers, polyolefins, in particular, polyethylene and polypropylene, polyacrylic compounds, polyvinyl compounds, for example polyvinyl chloride and polyvinyl acetate, polyesters and rubber, and also filaments made of viscose and cellulose ethers, cellulose esters, polyamides, polyurethanes, polyesters, for example polyglycol terephthalates, and polyacrylonitrile.

For a well-rounded introduction to a variety of pigment applications, see Temple C. Patton, editor, The Pigment Handbook, volume II, Applications and Markets, John Wiley and Sons, New York (1973). In addition, see for example, with regard to ink: R. H. Leach, editor, The Printing Ink Manual, Fourth Edition, Van Nostrand Reinhold (International) Co. Ltd., London (1988), particularly pages 282-591; with regard to paints: C. H. Hare, Protective Coatings, Technology Publishing Co., Pittsburgh (1994), particularly pages 63-288. The foregoing references are hereby incorporated by reference herein for their teachings of ink, paint and plastic compositions, formulations and vehicles in which the compositions of this invention may be used including amounts of colorants. For example, the pigment may be used at a level of 10 to 15% in an offset lithographic ink, with the remainder being a vehicle containing gelled and ungelled hydrocarbon resins, alkyd resins, wax compounds and aliphatic solvent. The pigment may also be used, for example, at a level of 1 to 10% in an automotive paint formulation along with other pigments which may include titanium dioxide, acrylic lattices, coalescing agents, water or solvents. The pigment may also be used, for example, at a level of 20 to 30% in a plastic color concentrate in polyethylene.

In the cosmetic field, these pigments can be used in the eye area and in all external and rinse-off applications. Thus, they can be used in hair sprays, face powder, leg-makeup, insect repellent lotion, mascara cake/cream, nail enamel, nail enamel remover, perfume lotion, and shampoos of all types (gel or liquid). In addition, they can be used in shaving cream (concentrate for aerosol, brushless, lathering), skin glosser stick, skin makeup, hair groom, eye shadow (liquid, pomade, powder, stick, pressed or cream), eye liner, cologne stick, cologne, cologne emollient, bubble bath, body lotion (moisturizing, cleansing, analgesic, astringent), after shave lotion, after bath milk and sunscreen lotion.

For a review of cosmetic applications, see Cosmetics: Science and Technology, 2nd Ed., Eds: M. S. Balsam and Edward Sagarin, Wiley-Interscience (1972) and deNavarre, The Chemistry and Science of Cosmetics, 2nd Ed., Vols 1 and 2 (1962), Van Nostrand Co. Inc., Vols 3 and 4 (1975), Continental Press, both of which are hereby incorporated by reference.

Effect pigments may be incorporated into polyester and acrylic resins to produce sheets which resemble mother-of-pearl. Bismuth oxychloride pigments impart pearly luster whereas titanium dioxide coated mica pigments contribute color as well as luster. The cast sheets are often used in the manufacture of pearl buttons, table tops, trays, bath fixtures, room dividers, and other products.

A plastic pearl sheet has maximum luster when the plate-like crystals of the effect pigment are individually dispersed and uniformly oriented. Individual dispersion permits the platelets to assume the proper orientation without hindrance from adjacent platelets. Uniform orientation in which the platelets are parallel to one another imparts high luster with an appearance of smoothness and great depth.

According to L. M. Greenstein supra, buttons are typically made by a casting process wherein motion is applied by rotation, oscillation, or other means to maintain orientation of the effect pigment until the liquid resin solidifies. An unsaturated polyester may also be molded wherein the viscous nacreous resin is fed to cavities in a die with orientation occurring as the liquid flows.

A typical process for making buttons follows. 200 grams of unsaturated polyester resin is mixed with 3 grams of paste in a paper cup. 2.5 ml of accelerator is added to the polyester/crystal paste. This paste is stirred up and put into a dryer (set at 40 degrees C.). When the paste reaches 35-40 degrees C., it is removed and 2.5 ml hardener is stirred in. The paste is poured into the drum of the centrifugal caster and allowed to harden while it is rotating. The sheet of button material is removed from the drum's sides (inside) and evaluated.

In order to further illustrate the invention, various non-limiting examples will be set forth below. In these examples, as well as throughout the balance of this specification and claims, all parts and percentages are by weight and all temperatures are in degrees Centigrade unless otherwise indicated.

### INVENTIVE EXAMPLE 1 AND COMPARATIVES A, B, AND C

The starting material used was BiOCl prepared in a solvent based system consisting of nitrocellulose and non-oxidizing alkyd lacquers; and butyl acetate, isopropyl alcohol, and toluene as diluents.

For Inventive Example 1, triacetin (99.5+%, food grade) was used as the plasticizer. For Comparative A, dioctyl adipate (from Eastman Chem. and Pride Solvent) was used as the plasticizer. For Comparatives B and C, dibutyl phthalate was used as the plasticizer. Comparative B was made on the same laboratory equipment as Inventive Example 1 and Comparative A while Comparative C was made on plant equipment.

Each plasticizer (65.6 g (±0.1 g)) listed above was mixed with 100.0 g (±0.2 g) of the starting material described above, 4.4 g (±0.1 g) butyl acetate, and 44.3 g (±0.1 g) of lacquer 85C. Each mixture was hand mixed thoroughly for about one minute, then placed on a lab mixer for a 6-minute mix at 1000 RPMS. More sample was needed, so the procedure was repeated twice more (for each plasticizer) and combined together to produce about 600 g of paste of each product.

The stability of each product above was determined as follows. Each formulation (to be tested) was split up into 4×100 g samples, with the remainder (about 200 g) put aside to be used as the control. A 4 oz glass jar with a metal lid was used for each sample. Each lid was hand tightened and sealed with plastic tape.

For Inventive Example 1 and Comparatives A and B, each product was tested under four stability conditions labeled Condition I, II, III, IV, or V below. For Conditions I and II, each product went into a 50(±2)° C. oven. For Conditions III and IV, each product went into a 70(±2)° C. oven. Each oven was checked periodically for temperature during the test period. For Conditions I and III, each product was removed from their respective ovens after 14(±2) days. For Conditions II and IV, each product was removed from their respective ovens after 28 (±3) days. For Condition V which was a control, room temperature for 14 days was used.

The results are in Table 1 below.

TABLE 1

| Stability Condition | Inventive Example 1 | Comparative A | Comparative B |
|---|---|---|---|
| I | Sample had settled well | Sample had settled okay | Sample had settled |
| (50 (±2) ° C. | with a clear yellow liquid | with a cloudy yellow | okay with a cloudy |
| oven for 14 | on top (about half of the | (light) liquid on top (less | yellow (light) liquid on |
| (±2) days) | volume). | than half of the | top (about half of the |
| | | volume). | volume). |
| II | Sample had settled well | Sample had settled okay | Sample had settled ok |
| (50 (±2) ° C. | with a clear amber | with a cloudy yellow | with a clear amber |
| oven for 28 | (medium) liquid on top | (dark) liquid on top (less | (medium) liquid on top |
| (±3) days) | (about half of the | than half of the jar). | (about half of the |
| | volume). | | volume). |
| III | Sample had settled well | Sample had settled okay | Sample had settled well |
| (70 (±2) ° C. | with a clear amber | with a cloudy yellow | with a cloudy amber |
| oven for 14 | (dark) liquid on top | (dark) liquid on top (less | (light) liquid on top |
| (±2) days) | (about half of the | than half of the jar). | (about half of the |
| | volume). | | volume). |
| IV | Sample had settled well | Sample had settled okay | Sample had settled well |
| (70 (±2) ° C. | with a clear dark red- | with a cloudy amber | with a clear amber |
| oven for 28 | brown liquid on top | (medium) liquid on top | (dark) liquid on top |
| (±3) days) | (about half of the | (less than half of the | (about half of the |
| | volume). | volume). | volume). |
| V | Sample settled to about | Sample only settled to | Sample only settled to |
| (room temp.) | half the volume with a | about 2/3 volume with a | about 2/3 volume with |
| | clear yellow (very light). | cloudy white liquid on | a cloudy white liquid on |
| | | top. | top. |

Each of Inventive Example 1, Comparative A, and Comparative B was used to prepare a drawdown which is a coating of the product on paper. For each drawdown, a sample of the approximately 3% crystal paste was diluted to a lower crystal content with a drawdown liquor. The drawdowns of Inventive Example 1 were compared with Comparatives A, B, and C to evaluate quality, quality change, and color change.

The drawdown results are in Table 2 below where IE1 means Inventive Example 1, Comp. A means Comparative A, Comp. B means Comparative B, Comp. C means Comparative C, SCI means Stability Condition I, SC III means Stability Condition III, and SCV means Stability Condition V.

TABLE 2

| Stability Condition | Inventive Example 1 | Comparative A | Comparative B |
|---|---|---|---|
| I | No difference from IE1 at | Noticeably less coverage | No change from Comp. |
| (50 (±2) | SCV. Equal to Comp. B at | and gloss than Comp. A | B at SCV. |
| ° C. oven for | SCI. | at SCV. | |
| 14 (±2) days) | | | |
| II | No change from IE1 at | Noticeably less coverage | No change from Comp. |
| (50 (±2) | SCV. No difference from | and gloss than Comp A. | B at SCV. |
| ° C. oven for | IE1 at SCI. | at SCV. | |
| 28 (±3) days) | | | |
| III | A little loss of coverage | Significant loss of | Minimal loss of |
| (70 (±2) | and gloss from IE1 at | coverage and gloss | coverage and gloss |
| ° C. oven for | SCV. Similar coverage | compared with Comp. A | compared with Comp. B |
| 14 (±2) | and minimally less gloss | at SCV. | at SCV. |
| days) | than Comp. B at SCIII. | | |
| IV | A little loss of coverage | Significant loss of | Minimal loss of |
| (70 (±2) | and gloss compared with | coverage and gloss | coverage and gloss |
| ° C. oven for | IE1 at SCV and no | compared with Comp. A | compared with Comp. B |
| 28 (±3) | difference from IE1 at | at SCV. | at SCV and no change |
| days) | SCIII. Minimally less | | from Comp. B at SCIII. |
| | gloss and coverage than | | |
| | Comp. B at SCIV. | | |
| V | Equal to Comp. B at SCV. | Less coverage and gloss | Minimally more gloss |
| (room | | than Comp. B at SCV. | and coverage than |
| temp.) | | | Comparative C. |

To summarize the above, Comparative A shows a lack of quality from the room temperature sample to the 700 samples. Heating seemed to worsen the quality significantly.

Inventive Example 1 and Comparative B held up better. The 50° samples showed no change in quality up to 4 weeks worth of time. The 70° samples for both formulations showed quality loss in the first two weeks with no further degradation in the 4-week samples. Between the two formulations, Inventive Example 1 showed a marginal difference to Comparative B at 70° C. after 4 weeks. Comparative A is an unacceptable pigment because it does not work well, initially or heat-stressed due to the dioctyl adipate plasticizer.

We prepared fresh slides of the product of Inventive Example 1 and Comparative A and visually observed greater agglomeration in the Comparative A product.

### INVENTIVE EXAMPLE 2 AND COMPARATIVE D

Inventive Example 1 above was repeated and the result divided into two portions to make buttons for Inventive Example 2. One portion was kept at room temperature (IE2-RT) and the other portion was heated in a 70° C. oven, removed after 14 days, evaluated, and returned to the oven for 14 additional days for a total of 28 oven days (IE2-Oven).

Comparative B above was repeated and the result split into two to make buttons for Comparative D. One portion was kept at room temperature (Comp. D-RT) and the other portion was heated in a 700 oven, removed after 14 days, evaluated, and returned to the oven for 14 additional days for a total of 28 oven days (Comp. D-Oven).

The products were formulated into button resin and a sheet was formed comparing the room temperature portion with the oven heated portion for Inventive Example 2 and Comparative D.

Comparing Comp. D-RT and Comp. D-Oven after 14 days, there is a noticeable line demarking both sides of the sheet. The 14-day side shows a slight whitening and reduced gloss. Similar coverage (opacity) is also noted. No other color change noted.

Comparing Comp. D-RT and Comp. D-Oven after 28 days, there is a noticeable line demarking both sides of the sheet. The 28-day side shows a slight whitening and reduced gloss. There also seems to be a slight loss in coverage (opacity). No other color change noted.

Comparing IE2-RT and IE2-Oven after 14 days, there is a noticeable line demarking both sides of the sheet. The 14-day side shows slightly better gloss and slight darkening. Similar coverage (opacity) is also noted.

Comparing IE2-RT and IE2-Oven after 28 days, there is no noticeable line demarking both sides of the sheet. The 28-day side shows minimally better gloss, minimal darkening, and similar coverage (opacity).

To summarize the above, there seems to be a slight loss in gloss in the heated Comparative D sheets and there seems to be a slight increase in gloss in the heated Inventive Example 2 sheets. The gloss seems to be linked to the whitening/darkening effect.

Inventive Example 2 does not show any detrimental effects due to heating (70° C.) for up to 28 days. Heated Comparative D showed more degradation than heated Inventive Example 2.

Various changes and modifications can be made in the products and process of the present invention without departing from the spirit and scope thereof. The various embodiments that have been disclosed herein were for the purpose of further illustrating the invention but were not intended to limit it.

What is claimed is:

1. An effect pigment comprising:
(a) substrate optionally coated with metal oxide; and
(b) triacetin.

2. The effect pigment of claim 1 wherein said substrate (a) is platelet-like.

3. The effect pigment of claim 1 wherein said substrate (a) is coated with metal oxide.

4. The effect pigment of claim 2 wherein said platelet-like substrate (a) is bismuth oxychloride.

5. The effect pigment of claim 1 wherein said triacetin (b) is present at from about 0.75 to about 3.5 times said substrate (a).

6. An article comprising polymeric material (c) and said effect pigment of claim 1.

7. A sheet comprising said article of claim 6.

8. The article of claim 6 wherein said polymeric material (c) is polyester.

9. A button comprising said article of claim 8.

10. A button comprising:
(a) substrate optionally coated with metal oxide;
(b) phthalate-free plasticizer; and
(c) polymeric material.

11. The button of claim 10 wherein said substrate (a) is platelet-like.

12. The button of claim 10 wherein said substrate (a) is coated with metal oxide.

13. The button of claim 11 wherein said platelet-like substrate (a) is bismuth oxychloride.

14. The button of claim 10 wherein said phthalate-free plasticizer (b) is triacetin.

15. The button of claim 14 wherein said triacetin (b) is present at from about 0.75 to about 3.5 times said substrate (a).
